(19) United States
(12) Patent Application Publication
(10) Pub. No.: US 2018/0040990 A1
(43) Pub. Date: Feb. 8, 2018

(54) RECEPTACLE CONNECTOR AND CONNECTOR ASSEMBLY HAVING SAME

(71) Applicant: Molex, LLC, Lisle, IL (US)

(72) Inventor: Yun Fang YANG, Shanghai (CN)

(73) Assignee: Molex, LLC, Lisle, IL (US)

(21) Appl. No.: 15/661,173

(22) Filed: Jul. 27, 2017

(30) Foreign Application Priority Data
Aug. 8, 2016 (CN) 201620850743.2

(51) Int. Cl. H01R 13/6594; H01R 24/60

(52) U.S. Cl. CPC H01R 13/6594; H01R 24/60; H01R 2107/00

(57) ABSTRACT

A receptacle connector is provided which has an insulating body, a plurality of conductive terminals, two grounding latches and a metal shell. The body has a housing and a tongue. Each terminal has a mating portion, a soldering portion and a connecting portion. The mating portion is exposed on the tongue. The soldering portion extends outwardly from the housing. The terminals are divided into upper and lower rows. Each row has at least two grounding terminals and at least two power terminals. The latches are embedded in the body and are partly exposed to two sides of the tongue, and each have a ground soldering leg extending outwardly from the housing. The shell is fixed on the body and surrounds an outer periphery of the tongue to form a mating cavity. The latches are each interposed between the grounding terminals of the upper and lower rows.

### RELATED APPLICATIONS

This application claims priority to Chinese Application No. 201620850743.2, filed Aug. 8, 2016, which is incorporated herein by reference in its entirety.

### TECHNICAL FIELD

The present disclosure relates to an electrical connector assembly, particularly relates to an electrical connector assembly suitable for large current transfer application.

### BACKGROUND ART

As functions of portable electronic devices (such as mobile phones) become more and more powerful, energy consumption issue of the portable electronic devices has become increasingly prominent, fast charging technology is increasingly pursued by people. Chinese patent application CN201520619899.5 discloses an integral USB TYPE-C receptacle connector, which comprises a shell and an insertion assembly, the shell covers an outer side of the insertion assembly, the insertion assembly comprises an insulating body, a metal shielding sheet, upper row conductive terminals and lower row conductive terminals. The metal shielding sheet, the upper row conductive terminals and the lower row conductive terminals and the insulating body are integrally formed by insert molding. The upper row conductive terminals and the lower row conductive terminals each comprise two grounding terminals, two power terminals and three data terminals. Each conductive terminal comprises a mating portion, a connecting portion and a soldering portion. The mating portion of each grounding terminal comprises a grounding base and a grounding portion protruding from the grounding base. The soldering portion of each grounding terminal comprises a SMT portion extending backwardly from the connecting portion and a DIP portion extending downwardly from the connecting portion. A middle portion of the metal shielding sheet protrudes upwardly to act as a ground terminal, such a connector structure may meet large current transfer to a certain extent to realize fast charging. However such a connector structure needs to stamp upwardly the middle portion of the metal shielding sheet to form the ground terminal configuration, therefore it is more difficult in manufacturing and it is not ideal in the effect of carrying large current; in addition, such a connector structure is limited to USB TYPE-C specification that two pairs of power terminals and two pairs of grounding terminals are used to realize large current transfer, therefore it remains to make further improvement for some application circumstances requiring durable and stable large current transfer.

### SUMMARY

A technical problem to be resolved by the present disclosure is to overcome the deficiency existing in the above prior art and provides an electrical connector assembly which can be better suitable for application circumstances requiring durable and stable large current transfer.

In view of the above technical problem, the present disclosure provides a receptacle connector which comprises: an insulating body which comprises a housing and a tongue extending forwardly from the housing; a plurality of conductive terminals, each conductive terminal comprises a mating portion exposed on the tongue, a soldering portion extending outwardly from the housing and a connecting portion positioned between the mating portion and the soldering portion, the conductive terminals are divided into upper row conductive terminals and lower row conductive terminals, each row conductive terminals comprise at least two grounding terminals and at least two power terminals; at least one grounding latch embedded in the insulating body and partly exposed to two sides of the tongue and having a ground soldering leg extending outwardly from the housing; and a metal shell which is fixed on the insulating body and surrounds an outer periphery of the tongue to form a mating cavity. The at least one grounding latch is interposed between the grounding terminal of the upper row conductive terminals and the grounding terminal of the lower row conductive terminals and is laminated up-down and contacted to each other.

In some embodiments, the upper row conductive terminals and the lower row conductive terminals each comprise two grounding terminals respectively positioned at two sides of the tongue and two power terminals respectively adjacent to the two grounding terminals so as to form a power terminal and grounding terminal group at each of the two sides of the tongue.

In some embodiments, the connecting portions and the soldering portions of the grounding terminals and power terminals each have a widen width relative to the mating portion thereof.

In some embodiments, the upper row conductive terminals and the lower row conductive terminals each further comprise an auxiliary power terminal interposed between the power terminal and grounding terminal group in at least one side of the tongue.

In some embodiments, the connecting portion and the soldering portion of the auxiliary power terminal each have a widen width relative to the mating portion of the auxiliary power terminal.

In some embodiments, the upper row conductive terminals and the lower row conductive terminals each are provided with a plurality of signal terminals between the two power terminal and grounding terminal groups thereof.

In some embodiments, the receptacle connector comprises two grounding latches which are independent and respectively positioned in two sides of the insulating body, each grounding latch has a latching portion exposed to a side of the tongue, the ground soldering leg extending outwardly from the housing and a connection portion connected between the latching portion and the ground soldering leg.

In some embodiments, a sum of a thickness of the grounding latch and two thicknesses of the two grounding terminals at upper and lower sides of the grounding latch is equal to a thickness of the tongue.

In view of the above technical problem, the present disclosure provides an electrical connector assembly comprising a receptacle connector and a plug connector which cooperate with each other, the receptacle connector is the above receptacle connector.

In some embodiments, the plug connector comprises upper row conductive terminals and lower row conductive terminals which respectively correspond to the upper row conductive terminals and the lower row conductive terminals of the receptacle connector; the upper row conductive terminals and the lower row conductive terminals of the plug connector each comprise two grounding terminals positioned at the two sides of the tongue, two power terminals adjacent to the two grounding terminals and an auxiliary power terminal interposed between the power terminal and the grounding terminal positioned in at least one side of the tongue.

In comparison with the prior art, the grounding terminal in the upper row and the grounding terminal in the lower row and the grounding latch in the middle are laminated up-down and contacted to each other in the receptacle connector of the present disclosure, which can maximally increase the thickness of the conductive terminal on the limited thickness of the tongue, obtain smaller impedance so as to beneficially promote large current carrying ability of ground circuit and reduce operative temperature rising, can be better suitable for application circumstances of durable and stable large current transfer.

### BRIEF DESCRIPTION OF THE DRAWINGS

FIG. 1 is a perspective view of an embodiment of an electrical connector assembly of the present disclosure.

FIG. 2 is a perspective view of an embodiment of a receptacle connector of the present disclosure from another angle.

FIG. 3 is a front view of the embodiment of the receptacle connector of the present disclosure.

FIG. 4 is a cross sectional view taken along from a line A-A of FIG. 3.

FIG. 5 is an exploded perspective view of the embodiment of the receptacle connector of the present disclosure.

FIG. 6 is a further exploded perspective view on a basis of FIG. 5.

FIG. 7 is an exploded perspective view of FIG. 6 from another angle.

FIG. 8 is a further exploded perspective view on a basis of FIG. 6.

FIG. 9 is a perspective view of an embodiment of a plug connector of the present disclosure from another angle.

FIG. 10 is a front view of the embodiment of the plug connector of the present disclosure.

FIG. 11 is a cross sectional view taken along from a line B-B of FIG. 10.

FIG. 12 is an exploded perspective view of the embodiment of the plug connector of the present disclosure.

FIG. 13 is a further exploded perspective view on a basis of FIG. 12.

### DETAILED DESCRIPTION OF THE PREFERRED EMBODIMENTS

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

Hereinafter, embodiments of the present disclosure will be further described in detail in combination with figures.

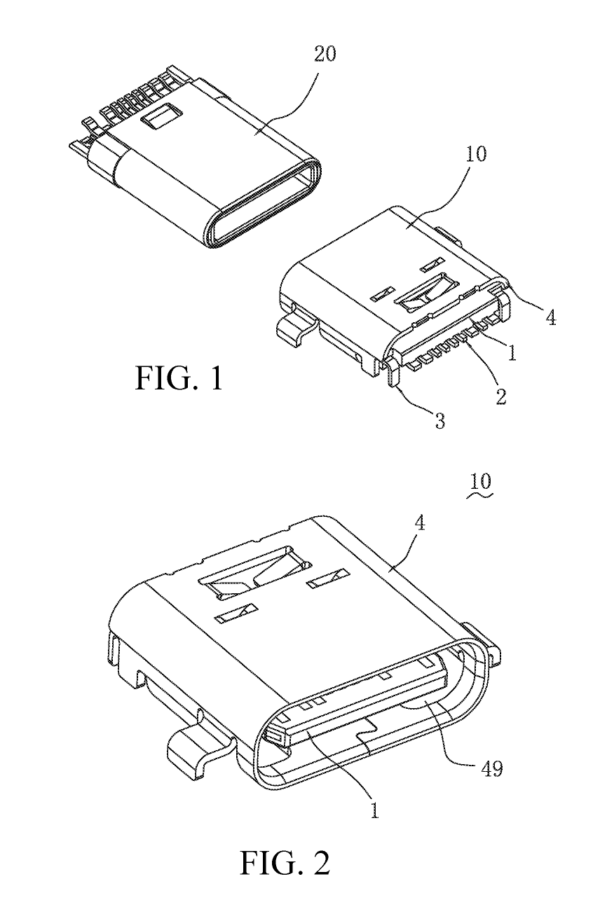

Referring to FIG. 1, the present disclosure provides an USB type-C connector assembly for large current transfer (8-10A) application, which comprises a receptacle connector 10 and a plug connector 20 which cooperate with each other.

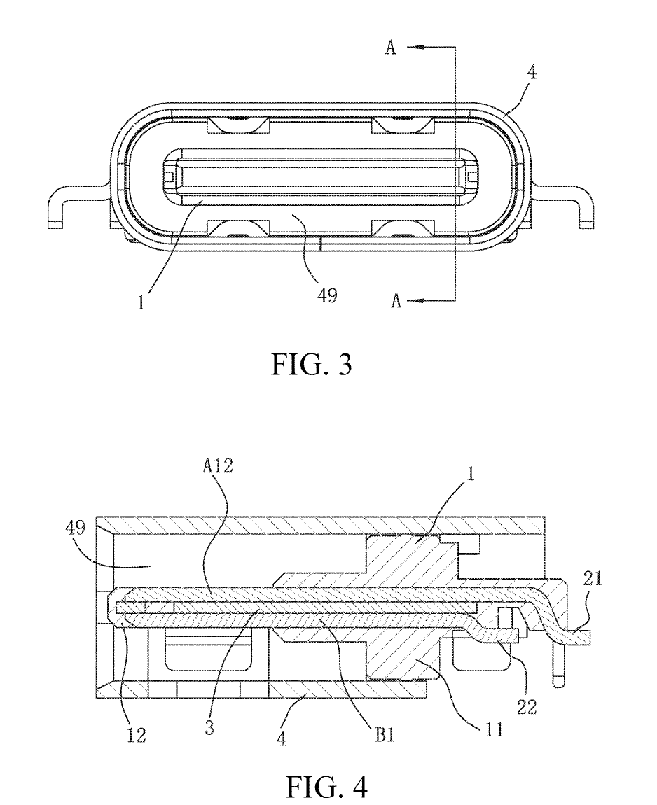

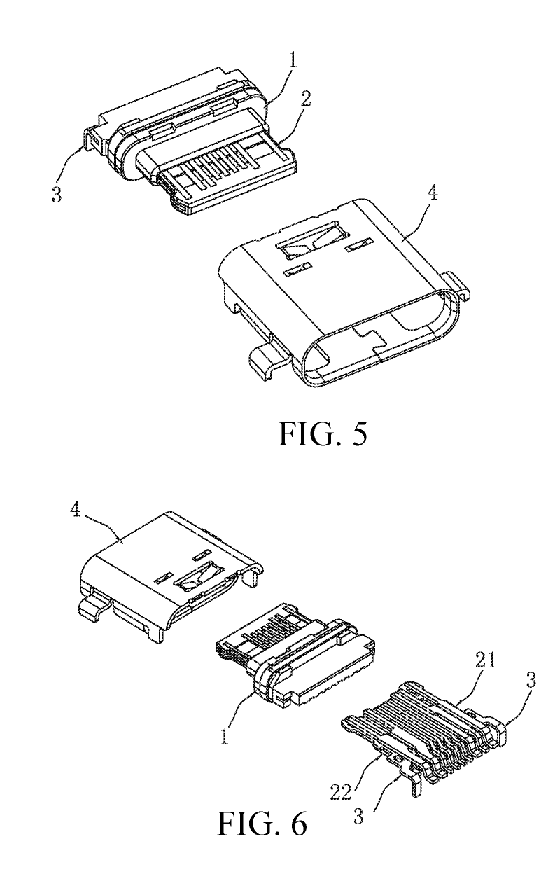

Referring to FIG. 2 to FIG. 8, the receptacle connector 10 comprises: an insulating body 1, a plurality of conductive terminals 2 embedded in the insulating body 1, two grounding latches 3 embedded in two sides of the insulating body 1, and a metal shell 4 fixed on the insulating body 1.

The insulating body 1 and the conductive terminals 2 and the two grounding latches 3 are engaged together by insert molding process. The insulating body 1 comprises a housing 11 and a tongue 12 extending forwardly from the housing 11.

The conductive terminals 2 are integrally formed by stamping and bending a metal sheet. Each conductive terminal 2 comprises a mating portion 26 exposed on the tongue 12, a soldering portion 28 extending backwardly from the housing 11 and a connecting portion 27 connected between the mating portion 26 and the soldering portion 28. The conductive terminals 2 are divided into upper row conductive terminals 21 and lower row conductive terminals 22. In the embodiment, when viewing the receptacle connector 10 from the front to the rear, the conductive terminals 2 are arranged as the following table.

| A1 | A2 | A3 | A4 | A5 | A6 | A7 | A8 | A9 | A10 | A11 | A12 |
|---|---|---|---|---|---|---|---|---|---|---|---|
| GND | Null | VBUS | VBUS | CC1 | D+ | D− | SBU1 | VBUS | Null | Null | GND |
| GND | Null | Null | VBUS | SBU2 | D− | D+ | CC2 | VBUS | VBUS | Null | GND |
| B12 | B11 | B10 | B9 | B8 | B7 | B6 | B5 | B4 | B3 | B2 | B1 |

As can be seen from the table, in the conductive terminals 2, there are two pairs of grounding terminals A1, A12, B1, B12 and three pairs of power terminals A3, A4, A9, B3, B4, B9, in comparison with two pairs of grounding terminals A1, A12, B1, B12 and two pairs of power terminals A4, A9, B4, B9 of USB type-C connector specification, one pair of auxiliary power terminals A3, B3 is added.

Specifically, the upper row conductive terminals 21 comprise: a first grounding terminal A12 and a second grounding terminal A1 respectively positioned at two sides of the tongue 12, a first power terminal A9 and a second power terminal A4 respectively adjacent to the two grounding terminals A12, A1, an auxiliary power terminal A3 and four terminals A5, A6, A7, A8 for transferring data and providing a control signal. The first power terminal A9 and the first grounding terminal A12 form a power terminal and grounding terminal group at one side of the tongue 12, and the second power terminal A4 and the second grounding terminal A1 also form a power terminal and grounding terminal group at the other side of the tongue 12.

In the embodiment, the connecting portions 27 and the soldering portions 28 of the grounding terminals A1, A12 and power terminals A3, A4, A9 are widen (that is the connecting portions 27 and the soldering portions 28 of these terminals each have a widen width relative to the mating portion 26 thereof) so as to reduce impedances of these terminals and be beneficial to large current transfer. It should be noted that, based on requirement from connector power supply specification, in some embodiments which are not shown, the auxiliary power terminal A3 may be omitted so as to provide a larger widen space for the second grounding terminal A1 and the second power terminal A4.

At the first grounding terminal A12 and first power terminal A9 side, two high rate signal transfer terminal A10, A11 of the USB type-C connector specification are removed; that is to say, the first grounding terminal A12 and first power terminal A9 occupies a width space of the four terminals A9-A12 of the USB type-C connector specification, so that the first grounding terminal A12 and the first power terminal A9 can be partly widen.

At the second grounding terminal A1, second power terminal A4 and auxiliary power terminal A3 side, two high rate signal transfer terminals A2, A3 of the USB type-C connector specification are removed, the auxiliary power terminal A3 is added; that is to say, the second grounding terminal A1, second power terminal A4 and auxiliary power terminal A3 occupies a width location of the four terminals A1-A4 of the USB type-C connector specification, so that the second grounding terminal A1, the second power terminal A4 and the auxiliary power terminal A3 can be partly widen. The new added auxiliary power terminal A3 may promote current in a power circuit, so as to be beneficial to large current transfer to provide fast charging.

Similarly, the lower row conductive terminals 22 comprise: a first grounding terminal B12, a second grounding terminal B1, a first power terminal B9, a second power terminal B4, an auxiliary power terminal B3 and four terminals B5, B6, B7, B8 for transferring data and providing a control signal. In the embodiment, the connecting portions 27 and the soldering portions 28 of the grounding terminals B12, B1 and power terminals B9, B4, B3 are widen (that is the connecting portions 27 and the soldering portions 28 of these terminals each have a widened width relative to the mating portion 26 thereof) so as to reduce impedances of these terminals and be beneficial to large current transfer. Based on the requirement of the connector power supply specification, in some embodiments which are not shown, the auxiliary power terminal B3 may be omitted so as to provide a larger widen space for the second grounding terminal B1 and the second power terminal B4.

At the first grounding terminal B12 and first power terminal B9 side, the two high rate signal transfer terminals B10, B11 of the USB type-C connector specification are removed; that is to say, the first grounding terminal B12 and first power terminal B9 occupies a width location of four terminals B9-B12 of the USB type-C connector specification, so that the first grounding terminal B12 and the first power terminal B9 can be partly widen.

At the second grounding terminal B1, second power terminal B4 and auxiliary power terminal B3 side, two high rate signal transfer terminals B2, B3 of the USB type-C connector specification are removed, the auxiliary power terminal B3 is added; that is to say, the second grounding terminal B1, second power terminal B4 and auxiliary power terminal B3 occupies a width location of the four terminals B1-B4 of the USB type-C connector specification, so that the second grounding terminal B1, the second power terminal B4 and the auxiliary power terminal B3 can be partly widen. The added auxiliary power terminal B3 may promote power current so as to be beneficial to large current transfer to provide fast charging.

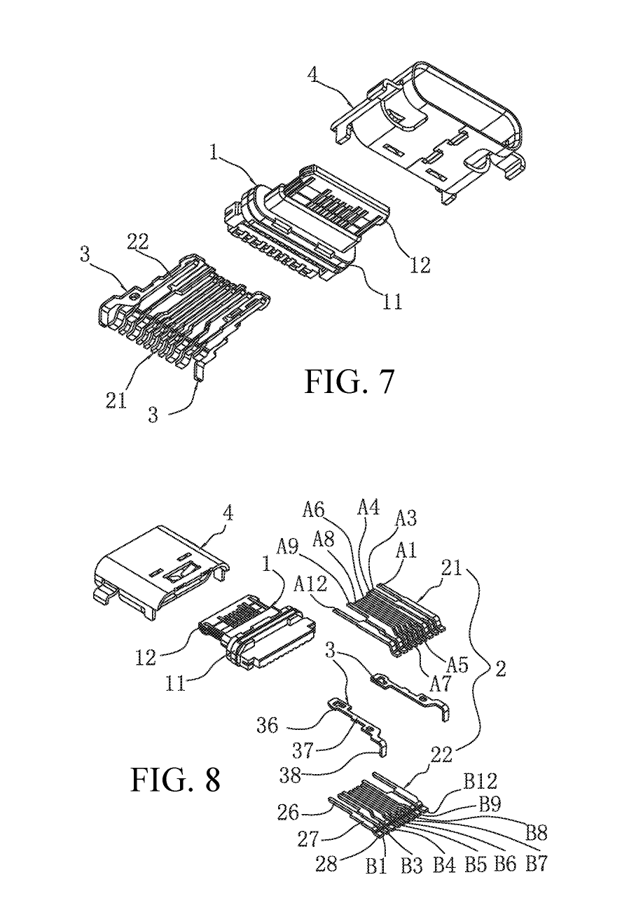

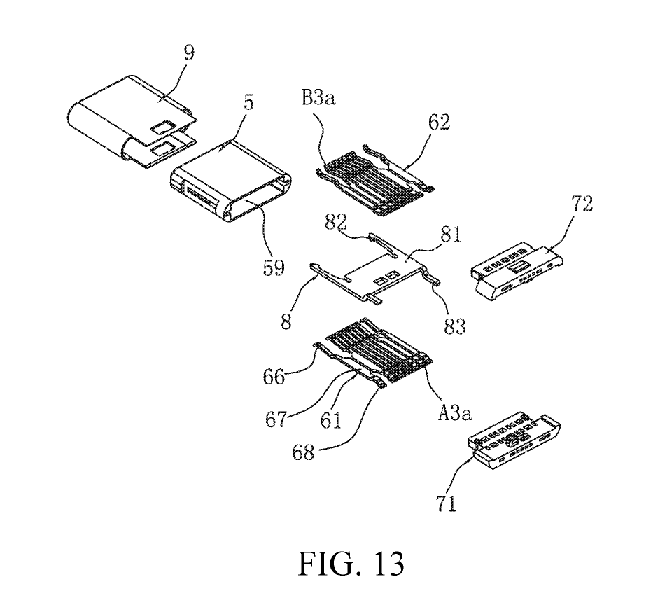

Referring to FIG. 7 and FIG. 8, the two grounding latches 3 are independent to each other and respectively provided in the two sides of the insulating body 1. Each grounding latch 3 comprises a latching portion 36 exposed to a side surface of the tongue 12, a ground soldering leg 38 extending backwardly from the housing 11 and a connection portion 37 connected between the latching portion 36 and the ground soldering leg 38. The ground soldering leg 38 may be soldered to an electrical ground, therefore the two grounding latches 3 are equivalent to add two grounding terminals, which is beneficial to promote current carrying ability of the ground circuit. In addition, the grounding latch 3 is made of a metal sheet, which is not easy to wear after the repeated use, may also enhance durability of the receptacle connector 10. Also, that a commonly used metal shielding sheet is simplified as two separate grounding latches 3 is beneficial to make a space for the middle power terminals A3, A4, A9, B9, B4, B3, in turn beneficial to increase thicknesses of the power terminals A3, A4, A9, B9, B4, B3. It should be noted that, in some embodiments which are not shown, the two grounding latches 3 of the receptacle connector 10 may also be designed as an integral latching hook member similar to the shielding sheet 8 shown in FIG. 13. And in some embodiments, one of the two grounding latches 3 may be further omitted.

Each grounding latch 3 is preferably respectively interposed between the grounding terminal A12, A1 of the upper row conductive terminals 21 and the grounding terminal B1, B12 of the lower row conductive terminals 22, are laminated up-down and contacted to each other. Specifically in combination with referring to FIG. 4, the mating portion 26 and connecting portion 27 of the grounding terminal A12, A1 of the upper row conductive terminals 21, the mating portion 26 and connecting portion 27 of the grounding terminal B1, B12 of the lower row conductive terminals 22 and the connection portion 37 of the grounding latch 3 are generally laminated up-down and contacted to each other, so that a thickness of the conductive terminal 2 may be maximally increased on the limited thickness of the tongue 12, and smaller impedance can be obtained; it is beneficial to promote current transfer ability of the ground circuit, and operative temperature rising of the connector resulted from heat generated is reduced. In the embodiment, the thickness of the conductive terminal 2 is selected as 0.25 millimeter, a thickness of the grounding latch 3 is selected as 0.20 millimeter, when these three members are laminated together, a total thickness is just equal to a thickness of 0.70 millimeter of the tongue 12 which complies with the USB type-C connector specification.

The metal shell 4 is formed by stamping and bending a metal sheet. The metal shell 4 covers and is fixed to an outer periphery of the insulating body 1, and surrounds an external space of the tongue 12 to form a mating cavity 49 so as to allow the plug connector 20 to correspondingly insert therein. The previous upper row conductive terminals 21 and the previous lower row conductive terminals 22 are arranged as one-hundred eighty (180) degree rotational symmetry in the mating cavity 49, so that it can support dual insertion orientation of the plug connector 20.

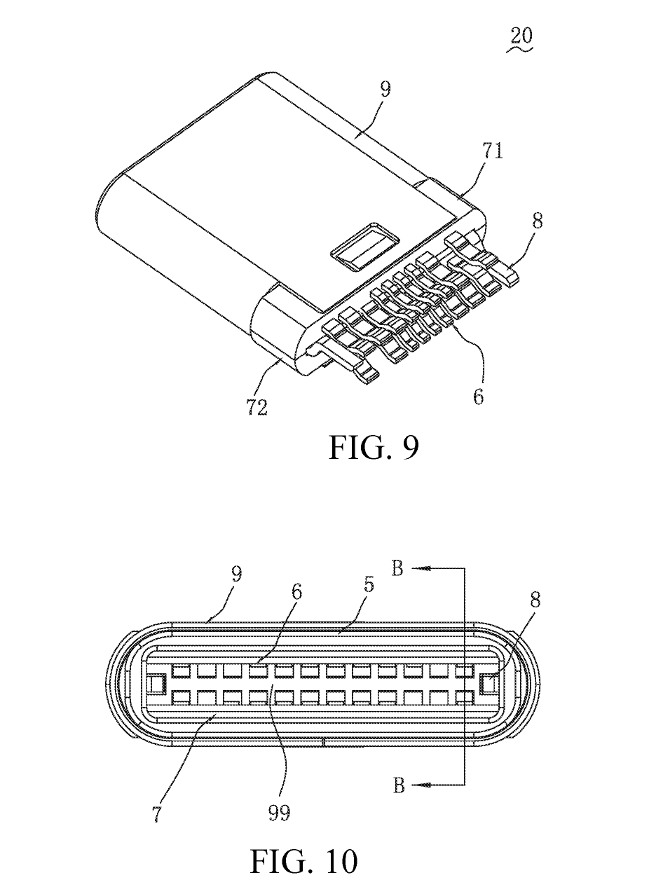

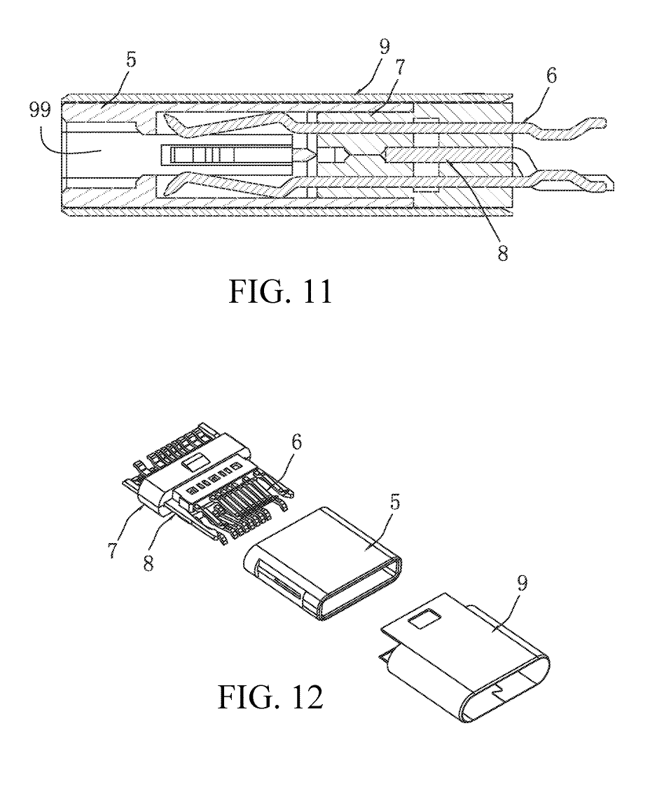

Referring to FIG. 9 to FIG. 13, the plug connector 20 comprises: a plastic body 5, a plurality of conductive terminals 6, a plastic member assembly 7, a shielding sheet 8 and an outer shell 9. The plastic body 5 is integrally formed by inject molding. The plastic body 5 has a receiving cavity 59 penetrating along a front-rear direction. An assembly composed of the conductive terminals 6, the shielding sheet 8 and the plastic member assembly 7 is mounted in the receiving cavity 59. The outer shell 9 is formed by stamping and bending a metal sheet. The outer shell 9 covers and is fixed to an outer periphery of the plastic body 5. The plug connector 20 has an insertion cavity 99 cooperating with the tongue 12 of the receptacle connector 10.

The conductive terminals 6 are integrally formed by stamping and bending a metal sheet. Each conductive terminal 6 comprises a mating portion 66, a soldering portion 68 and a connecting portion 67 connected between the mating portion 66 and the soldering portion 68. The conductive terminals 6 are divided into upper row conductive terminals 61 and lower row conductive terminals 62. The upper row conductive terminals 61 and the lower row conductive terminals 62 are arranged as one-hundred eighty (180) degree rotational symmetry along an outer periphery of the insertion cavity 99, so that the plug connector 20 can be inserted into the receptacle connector 10 in dual insertion orientation to realize mating. Specifically, the upper row conductive terminals 61 and the previous upper row conductive terminals 21 are the same in arrangement, the lower row conductive terminals 62 and the previous upper row conductive terminals 22 are the same arrangement, so the detailed description is omitted herein. It should be noted that, in comparison with two pairs of grounding terminals and two pairs of power terminals of the USB type-C connector specification, these conductive terminals 6 add a pair of auxiliary power terminals A3a, B3a corresponding to the auxiliary power terminals A3, B3 of the previous receptacle connector 10.

The plastic member assembly 7 comprises an upper plastic member 71 and a lower plastic member 72 which cooperate with each other. The upper plastic member 71 and the upper row conductive terminals 61 are engaged together by insert molding process to constitute an upper terminal module. Similarly, the lower plastic member 72 and the lower row conductive terminals 62 are engaged together by insert molding process constitute a lower terminal module.

The shielding sheet 8 is interposed between the upper terminal module and the lower terminal module. In the embodiment, the shielding sheet 8 comprises a base plate 81 interposed between the upper plastic member 71 and the lower plastic member 72, two latching hooks 82 respectively extending forwardly from two sides of a front end of the base plate 81, and two ground soldering legs 83 extending backwardly from a rear end of the base plate 81. The two ground soldering legs 83 may be correspondingly soldered to an electrical ground.

Return to referring to FIG. 1, when the plug connector 20 and the receptacle connector 10 are engaged together, the tongue 12 of the receptacle connector 10 will correspondingly insert into the insertion cavity 99 of the plug connector 20, at this time, the upper row conductive terminals 61 of the plug connector 20 and the upper row conductive terminals 21 of the receptacle connector 10 are mated with each other in one terminal to one terminal correspondence and are electrically connected together; the lower row conductive terminals 62 of the plug connector 20 and the lower row conductive terminals 22 of the receptacle connector 10 are mated with each other in one terminal to one terminal correspondence and electrically connected together; the two latching hooks 82 of the plug connector 20 and the two grounding latches 3 of the receptacle connector 10 are mated with each other in one latching hook to one latching hook correspondence and electrically connected together.

In comparison with the prior art, in the electrical connector assembly of the present disclosure, the grounding terminal A1, A12 in the upper row and the grounding terminal B1, B12 in the lower row and the grounding latch 3 in the middle are laminated up-down and contacted to each other in the receptacle connector 10, such a design utilizes simple and more easily realized laminating structure, can maximally increase the thickness of the conductive terminal 2 on the limited thickness of the tongue 12, obtain smaller impedance so as to beneficially promote large current carrying ability of ground circuit and reduce operative temperature rising; in addition, the receptacle connector 10 and the plug connector 20 each add a pair of auxiliary power terminals A3, B3, A3a, B3a, which is also beneficial to further promote large current carrying ability of the power circuit, thus can be better suitable for application circumstances of durable and stable large current transfer.

The above contents are only embodiment of the present disclosure and are not used to limit the implementing solutions of the present disclosure. Those skilled in the art may conveniently vary or modify based on the main concept and spirit of the present disclosure, therefore the extent of protection of the present disclosure shall be determined by the terms of the Claims.

What is claimed is:

1. A receptacle connector, comprising:
an insulating body which comprises a housing and a tongue extending forwardly from the housing;
a plurality of conductive terminals, each conductive terminal comprising a mating portion exposed on the tongue, a soldering portion extending outwardly from the housing and a connecting portion positioned between the mating portion and the soldering portion, the conductive terminals being divided into upper row conductive terminals and lower row conductive terminals, each row conductive terminals comprising at least two grounding terminals and at least two power terminals;
at least one grounding latch embedded in the insulating body and partly exposed to two sides of the tongue and having a ground soldering leg extending outwardly from the housing; and
a metal shell which is fixed on the insulating body and surrounds an outer periphery of the tongue to form a mating cavity;
the at least one grounding latch being interposed between the grounding terminal of the upper row conductive terminals and the grounding terminal of the lower row conductive terminals and being laminated up-down and contacted to each other.

2. The receptacle connector according to claim 1, wherein the upper row conductive terminals and the lower row conductive terminals each comprise two grounding terminals respectively positioned at the two sides of the tongue and two power terminals respectively adjacent to the two grounding terminals so as to form a power terminal and grounding terminal group at each of the two sides of the tongue.

3. The receptacle connector according to claim 2, wherein the connecting portion and the soldering portion of the auxiliary power terminal each have a widen width relative to the mating portion of the auxiliary power terminal.

4. The receptacle connector according to claim 2, wherein the upper row conductive terminals and the lower row conductive terminals each are provided with a plurality of signal terminals between the two power terminal and grounding terminal groups thereof.

5. The receptacle connector according to claim 4, wherein the receptacle connector comprises two grounding latches which are independent and respectively positioned in two sides of the insulating body, each grounding latch has a latching portion exposed to a side of the tongue, the ground soldering leg extending outwardly from the housing and a connection portion connected between the latching portion and the ground soldering leg.

6. The receptacle connector according to claim 2, wherein the connecting portions and the soldering portions of the grounding terminals and power terminals each have a widen width relative to the mating portion thereof.

7. The receptacle connector according to claim 6, wherein the connecting portion and the soldering portion of the auxiliary power terminal each have a widen width relative to the mating portion of the auxiliary power terminal.

8. The receptacle connector according to claim 6, wherein the upper row conductive terminals and the lower row conductive terminals each are provided with a plurality of signal terminals between the two power terminal and grounding terminal groups thereof.

9. The receptacle connector according to claim 8, wherein the receptacle connector comprises two grounding latches which are independent and respectively positioned in two sides of the insulating body, each grounding latch has a latching portion exposed to a side of the tongue, the ground soldering leg extending outwardly from the housing and a connection portion connected between the latching portion and the ground soldering leg.

10. The receptacle connector according to claim 2, wherein the upper row conductive terminals and the lower row conductive terminals each further comprise an auxiliary power terminal interposed between the power terminal and grounding terminal group in at least one side of the tongue.

11. The receptacle connector according to claim 10, wherein the connecting portion and the soldering portion of the auxiliary power terminal each have a widen width relative to the mating portion of the auxiliary power terminal.

12. The receptacle connector according to claim 10, wherein the upper row conductive terminals and the lower row conductive terminals each are provided with a plurality of signal terminals between the two power terminal and grounding terminal groups thereof.

13. The receptacle connector according to claim 12, wherein the receptacle connector comprises two grounding latches which are independent and respectively positioned in two sides of the insulating body, each grounding latch has a latching portion exposed to a side of the tongue, the ground soldering leg extending outwardly from the housing and a connection portion connected between the latching portion and the ground soldering leg.

14. The receptacle connector according to claim 10, wherein the connecting portion and the soldering portion of the auxiliary power terminal each have a widen width relative to the mating portion of the auxiliary power terminal.

15. The receptacle connector according to claim 14, wherein the upper row conductive terminals and the lower row conductive terminals each are provided with a plurality of signal terminals between the two power terminal and grounding terminal groups thereof.

16. The receptacle connector according to claim 14, wherein the receptacle connector comprises two grounding latches which are independent and respectively positioned in two sides of the insulating body, each grounding latch has a latching portion exposed to a side of the tongue, the ground soldering leg extending outwardly from the housing and a connection portion connected between the latching portion and the ground soldering leg.

17. The receptacle connector according to claim 16, wherein a sum of a thickness of the grounding latch and two thicknesses of the two grounding terminals at upper and lower sides of the grounding latch is equal to a thickness of the tongue.

18. An electrical connector assembly, comprising a receptacle connector and a plug connector which cooperate with each other, wherein the receptacle connector is the receptacle connector according to claim 1.

19. The electrical connector assembly according to claim 18, wherein the plug connector comprises upper row conductive terminals and lower row conductive terminals which respectively correspond to the upper row conductive terminals and the lower row conductive terminals of the receptacle connector; the upper row conductive terminals and the lower row conductive terminals of the plug connector each comprise two grounding terminals positioned at the two sides of the tongue, two power terminals adjacent to the two grounding terminals and an auxiliary power terminal interposed between the power terminal and the grounding terminal positioned in at least one side of the tongue.
